(19) United States
(12) Patent Application Publication
(10) Pub. No.: US 2018/0008888 A1
(43) Pub. Date: Jan. 11, 2018

(54) METHOD AND PROGRAM FOR PROVIDING GAME BASED ON TOUCH SCREEN

(71) Applicant: DEXINT GAMES Inc., Seoul (KR)

(72) Inventor: Jae Ho KIM, Seoul (KR)

(73) Assignee: DEXINT GAMES Inc., Seoul (KR)

(21) Appl. No.: 15/632,727

(22) Filed: Jun. 26, 2017

(30) Foreign Application Priority Data
Jul. 6, 2016 (KR) 10-2016-0085307

(51) Int. Cl. A63F 13/2145; A63F 13/822; A63F 13/56; A63F 13/825; A63F 13/45

(52) U.S. Cl. CPC A63F 13/2145; A63F 13/825; A63F 13/45; A63F 13/56; A63F 13/822

(57) ABSTRACT

A method and program for providing a game based on a touch screen is provided. The method includes obtaining, by a computer, a reference game image on which a plurality of characters operated according to a user input start from different points, the reference game image being obtained relative to a view point in a game space, generating, by the computer, a conversion game image by converting the reference game image into the conversion game image as one or more characters corresponding to each user move from a first side to a second side, and combining and providing, by the computer, an operation interface with the conversion game image.

### CROSS-REFERENCE TO RELATED APPLICATIONS

A claim for priority under 35 U.S.C. §119 is made to Korean Patent Application No. 10-2016-0085307 filed Jul. 6, 2016, in the Korean Intellectual Property Office, the entire contents of which are hereby incorporated by reference.

### BACKGROUND

Embodiments of the inventive concept described herein relate to a method and program for providing a game based on a touch screen, and more particularly, relate to a method and program for providing a game screen to address occurrence of an advantage or disadvantage according to a movement direction of a character when a game is performed using a touch screen.

Recently, there has been an explosion in the number of users of smart devices such as smartphones, each of which has a touch screen as an input means. Further, various types of applications available in a variety of fields, which are application programs executed in the smart devices, have been developed.

Particularly, game applications among applications in various fields comprise a large proportion of the applications. Role-playing games (RPGs) among such game applications are a large part of the applications.

An RPG generally called an “RPG game” may be a game such that a gamer accomplishes missions or goals given to his or her own character in a game space. The gamer may participate in a game in various ways according to missions or roles given to him or her.

It is not difficult to perform various play operations of a character by using a keyboard or a mouse in a conventional personal computer (PC)-based RPG. However, a smart device based on a touch screen may display various types of virtual keypads on the touch screen without having a separate physical device as an input device, such that a gamer operates the virtual keypad provided on a game screen to input data to the smart device.

The smart device may allow a gamer to touch a virtual keypad formed on a game screen without a separate input device (means) and input data through the touch screen. In case of an RPG based on the smart device, a movement key for moving a character on a game screen and control keys, such as a selection key, a confirm key, an attack key, a defense key, an evasion key, a cancel key, an item key, and a skill key, for a variety of control of a character may be formed. A gamer may operate his or her own character by touching the movement key and the control keys which are virtual keypads formed on a game screen.

### SUMMARY

Embodiments of the inventive concept provide a method and program for providing a game to prevent a winning rate from being changed as a handicap occurs based on a movement direction of a character when a game is performed using a movement key and a control key.

Embodiments of the inventive concept provide a method and program for providing a game to provide a movement direction of a character, which is convenient for a user to perform a game, while using a game result calculation scheme used in a conventional interactive game without change.

According to an aspect of an embodiment, a method for providing a game based on a touch screen may include obtaining, by a computer, a reference game image on which a plurality of characters operated according to a user input start from different points, the reference game image being obtained relative to a view point in a game space, generating, by the computer, a conversion game image by converting the reference game image into the conversion game image as one or more characters corresponding to each user move from a first side to a second side, and combining and providing, by the computer, an operation interface with the conversion game image.

The method may further include receiving a conversion input operation through the operation interface, the conversion input operation being as an input operation of a user on the conversion game image, converting the conversion input operation into a reference input operation, the reference input operation being as an input operation of the user on the reference game image, and applying movement or ability use of a character based on the reference input operation.

The operation interface may include a movement key configured to determine a movement direction of the character and a control key configured to select ability used by the character. The movement key may be located at a first side on a screen of a mobile terminal. The control key may be located at a second side on the screen of the mobile terminal.

The game may allow a first character according to an operation of a first user to use his or her ability while moving from the first side to the second side. The game may allow a second character according to an operation of a second user to use his or her ability while moving from the second side to the first side. The generating of the conversion game image may include generating the reference game image as the conversion game image for the second user as the second character moves from the first side to the second side.

The receiving of the conversion input operation may include receiving a first selection input for ability of a second character displayed on the control key on the conversion game image and receiving a second selection input on an application point on the screen. The application point may be a first character which appears at the second side on the conversion game image as the first character starts from a location opposite to the second character on a game map or a region in a range from the first character.

The generating of the conversion game image may include generating the conversion game image by multiplying the reference game image by a projection matrix.

The generating of the conversion game image may include, if a user performs a game with a virtual user, not performing a conversion process if a start point of a character of the user is determined as a first side on a symmetric game map or an asymmetric game map and generating the conversion game image by converting the reference game image into the conversion game image if the start point of the character of the user is determined as a second side on the asymmetric game map.

According to another aspect of an embodiment, a program for providing a game based on a touch screen may be combined with hardware, execute a method for providing a game based on a touch screen, and be stored in a medium.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart illustrating a method for providing a game based on a touch screen according to an embodiment;

FIG. 2 is a drawing illustrating a conversion game image according to an embodiment; and

FIG. 3 is a flowchart illustrating a method for providing a game based on a touch screen to reflect a conversion input operation input from a user in a performed game according to an embodiment.

### DETAILED DESCRIPTION

Advantages, features, and methods of accomplishing the same will become apparent with reference to embodiments described in detail below together with the accompanying drawings. However, the inventive concept is not limited by embodiments disclosed hereinafter, and may be implemented in various forms. Rather, these embodiments are provided to so that this disclosure will be through and complete and will fully convey the concept of the invention to those skilled in the art, and the inventive concept will only be defined by the appended claims.

Terms used in the specification are used to describe embodiments of the inventive concept and are not intended to limit the scope of the inventive concept. In the specification, the terms of a singular form may include plural forms unless otherwise specified. The expressions “comprise” and/or “comprising” used herein indicate existence of one or more other elements other than stated elements but do not exclude presence of additional elements. The same reference numerals refer to the same elements through the specification. “And/or” includes each of the above-mentioned elements and one or more combinations thereof. Although the terms “first”, “second”, and the like are used to describe various elements, it is obvious that these elements are not limited by these terms. These terms are only used to distinguish one element from another element. Thus, a first element discussed below could be termed a second element without departing from the technical scope of the inventive concept.

Unless otherwise defined herein, all terms (including technical and scientific terms) used in the specification may have the same meaning that is generally understood by a person skilled in the art. Also, terms which are defined in a dictionary and commonly used should be interpreted as not in an idealized or overly formal detect unless expressly so defined.

Spatially relative terms, such as “below,” “beneath,” “lower,” “above,”, “upper,” and the like may be used herein for ease of description to describe one element or feature's relationship to another element(s) or feature(s) as illustrated in the drawings. It should be understood that these spatially relative terms are intended to encompass different orientations of the device in use or operation in addition to the orientation shown in the drawings. For example, if the device in the drawings is turned over, elements described as “below” or “beneath” other elements or features would then be oriented “above” the other elements or features. Thus, the exemplary term “below” can encompass both an orientation of above and below. The device may be otherwise oriented and the spatially relative descriptors used herein interpreted accordingly.

In the specification, a computer may include all of various devices which may perform arithmetic processing and may provide the result to a user. For example, the computer may correspond to a smartphone, a tablet personal computer (PC), a cellular phone, a personal communication service (PCS) phone, a synchronous/asynchronous international mobile telecommunication-2000 (IMT-2000) mobile terminal, a palm PC, a personal digital assistant (PDA), or the like as well as a desktop PC or a notebook. Further, the computer may correspond to a server which receives a request from a client and perform information processing.

Hereinafter, a description will be given in detail of an embodiment of the inventive concept with reference to the accompanying drawings.

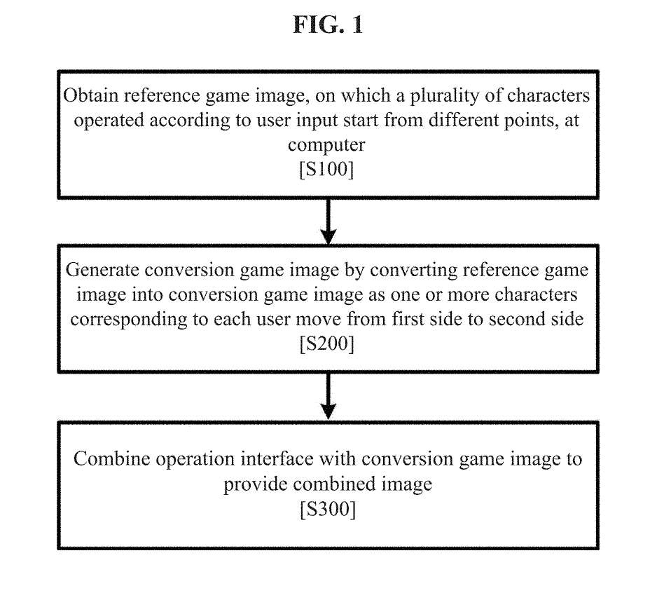

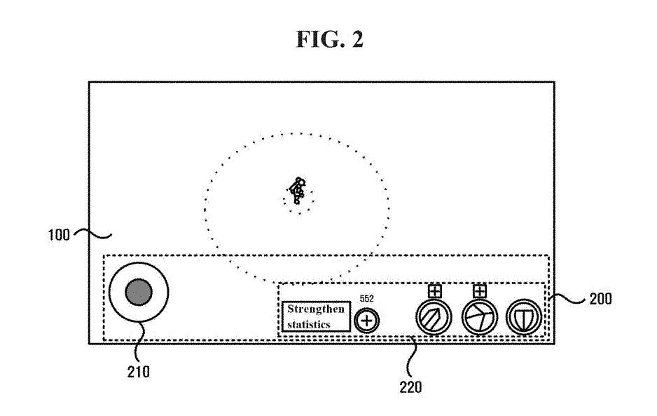

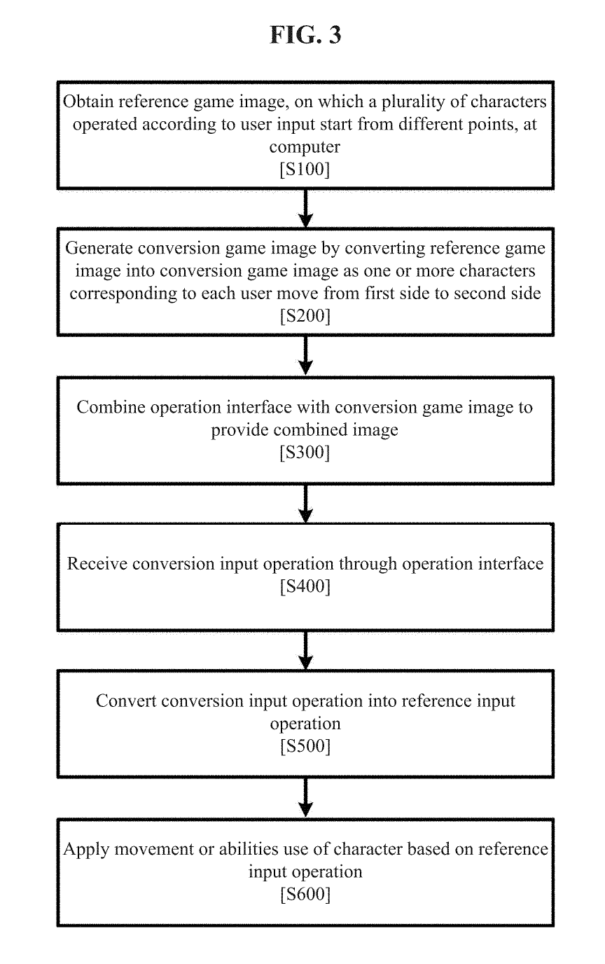

FIG. 1 is a flowchart illustrating a method for providing a game based on a touch screen according to an embodiment. FIG. 2 is a drawing illustrating a conversion game image according to an embodiment. FIG. 3 is a flowchart illustrating a method for providing a game based on a touch screen to reflect a conversion input operation input from a user in a performed game according to an embodiment. Referring to FIG. 1, a method for providing a game based on a touch screen according to an embodiment may include obtaining, by a computer, a reference game image on which a plurality of characters operated according to a user input start from different points in operation S100, generating, by the computer, a conversion game image 100 in operation S200 by converting the reference game image into the conversion game image 100 as one or more characters corresponding to each user move from a first side to a second side, and combining, by the computer, an operation interface 200 with the conversion game image 100 in operation S300 to provide the combined image. Hereinafter, a description will be given in detail of each of operations 100, 200, and 300.

In operation S100, the computer may obtain the reference game image on which the plurality of characters operated according to the user input start from the different points. The reference game image may be an image obtained with respect to a specific view point in a game space.

As an embodiment, in case of a massive multiplayer online role-playing game (MMORPG), a plurality of characters controlled by a plurality of users may start from different points on a three-dimensional (3D) game map. Specifically, if two users perform a game or if two groups perform the game (i.e., if three or more users are divided into two sides and perform the game when they perform the game in one game map), the computer may generate 3D graphics such that a character (e.g., one specific character or a set of a plurality of characters) controlled by each user moves from an opposite side (e.g., a left or right side) on a game map. The computer may obtain an image for a character of a first user and an image for a character of a second user in a direction of a specific view point on the generated 3D graphics and may obtain each of the obtained images as a reference game image for a character of each user. For example, as shown in FIG. 2, if a character of a first user (or a first user group) and a character of a second user (or a second user group) start from the east and the west on a 3D game map, respectively, the computer may generate a reference game image for each character from a view point of a south upper direction.

In operation S200, the computer may generate the conversion game image 100 by converting the reference game image into the conversion game image 100 as the one or more characters corresponding to each user move from the first side to the second side. One or more characters of each user in the reference game image may start from different directions and may move in a specific direction to perform a game (e.g., combat) with a counterpart character.

For example, if first and second users start from opposite sides and move to perform combat, a character of the first user moves from a first side (e.g., the left) to a second side (e.g., the right) in the reference game image and a character of the second user may move from the second side (e.g., the right) to the first side (e.g., the left) in the reference game image. In other words, the game may allow the first character according to an operation of the first user to use his or her ability while moving from the first side to the second side and may allow the second character according to an operation of the second user to use his or her ability while moving from the second side to the first side. In this case, in operation S200 of generating the conversion game image 100, the computer may generate the reference game image as the conversion game image 100 for the second user as the second character moves from the first side to the second side.

Further, if three or more users perform a game in one game map, one or more characters of each user move in different movement directions. For example, if four users separately perform combat without having a team, since respective users start a game at a first side, a second side, a third side, and a fourth side on a game map and move in a central direction of the game map, one or more characters of each user may move in different directions in the game map. In this case, to prevent the result of performing a game from being changed because there is a difference in the convenience of controlling a character according to a start location when each user performs the game, the computer may perform image conversion such that one or more user's own characters moves in the same movement direction (e.g., such that one or more characters of each user move from the left to the right) on a game screen provided to each user.

In other words, it may be most favorable to a user who moves his or her character in a specific movement direction (e.g., a direction in which a counterpart character appears at a side where a control key 220 of an operation interface 200 to be described below is located) in terms of control of the character. For example, if a character is moved and controlled based on the operation interface 200 displayed on a touch screen of a mobile terminal, when the character moves in a direction (e.g., a second side) where a counterpart character appears around a location on a screen of the control key 220 which controls a skill of the character, it may be most favorable to operation of the game since it is easy to select the counterpart character or a region adjacent to the counterpart character after the control key 200 is operated.

Thus, the computer may generate the conversion game image 100 by converting an image to move one or more characters for each of users who moves in different directions in the same game map (i.e., move from a first side to a second side). For example, if there are first and second users playing on a game map, the computer may perform image conversion for the second user who moves from the second side to the first side in the reference game image without performing image conversion for the first user who moves from the first side to the second side in the reference game image.

Operation S200 of generating the conversion game image 100 may be performed as the computer performs an arithmetic operation of multiplying the reference game image which is a graphic image by a specific matrix. For example, if characters of two users (i.e., the first user and the second user) move from start points, located at opposite sides in one game map, in a reverse direction, the computer may generate the conversion game image 100 by multiplying the reference game image by a projection matrix.

Further, if a specific user performs a game with a virtual user, the computer may determine whether to operation S200 of generating the conversion game image 100 depending on a situation. If the result of performing the game does have an influence on a start point as a game map is formed in a symmetric manner, the computer may locate one or more characters of the specific user (i.e., a real user) to move from the first side to the second side and may locate one or more characters of the virtual user to a start point where the one or more characters of the virtual user moves in a movement direction rather than the motion direction from the first side to the second side. Therefore, it may be unnecessary for a process of converting a game image to be provided to the user (i.e., the real user).

On the other hand, the computer may perform an arithmetic operation and may determine a start point one or more characters of a user will start on an asymmetric game map. If the start point of the characters of the user is determined as the first side, the computer may fail to perform a conversion process. If the start point of the characters of the user is determined as the second side, the computer may generate the conversion game image 100 by converting the reference game image into the conversion game image 100.

In operation S300, the computer may combine the operation interface 200 with the conversion game image 100 to provide the combined image. The operation interface 200 may refer to an interface including an operation key necessary for a user to operate his or her character when performing a game. For example, if the user performs a game using his or her mobile terminal having a touch screen, the operation interface 200 may be an interface for controlling the character by a touch operation of the user as displayed on the touch screen.

In other words, the operation interface 200 may include a movement key for determining a movement direction of the character and the control key 220 for selecting ability used by the character. The movement key may refer to a key for moving a character on a game screen. The control key 220 may be a key for a variety of control of a character, for example, for using a skill or item in a process where the user performs a game and may include a selection key, a confirm key, an attack key, a defense key, an evasion key, a cancel key, an item key, a skill key, and the like.

The movement key and the control key 220 may be located at different one sides of a screen on the operation interface 200. For example, the movement key may be located at a first side on a screen of the mobile terminal, and the control key 220 may be located at a second side on the screen of the mobile terminal. Therefore, the user may operate the control key 220 located the second side on the touch screen with his or her finger (e.g., his or her thumb) and may simply specify a counterpart character located at the second side or a point adjacent to the counterpart character with the finger (e.g., the thumb).

Further, as shown in FIG. 3, the method for providing a game based on the touch screen may further include receiving a conversion input operation through the operation interface 200 in operation S400, the conversion input operation being as an input operation of a user on the conversion game image 100, converting the conversion input operation into a reference input operation in operation S500, the reference input operation being as an input operation of the user on the reference game image, and applying movement or ability use of a character based on the reference input operation in operation S600.

In operation S400, the computer may receive the conversion input operation from the user through the operation interface 200. The conversion input operation may be the input operation of the user on the conversion game image 100. For example, if the movement key and the control key 220 are located on the operation interface 200, the computer may receive an operation of the movement key or the control key 220 on the touch screen for character control from the user and transmit the received operation.

Further, for example, the computer may receive an input for selecting specific ability (e.g., a skill or item) of a character of the user and may receive an input for selecting a counterpart character or point to be applied. In detail, operation S400 of receiving the conversion input operation may include receiving a first selection input for specific ability of the second character displayed on the control key 220 in the conversion game image 100 and receiving a second selection input on an application point on the screen. The application point may be the first character oneself who appears at the second side on the conversion game image 100 as the first character starts from a location opposite to the second character on a game map or a region in a specific range from the first character.

In operation S500, the computer may convert the conversion input operation into the reference input operation. The reference input operation may be the input operation of the user on the reference game image. In other words, to generate a real-time image of a game played by a plurality of users, the computer should calculate the result of performing the game in real time by reflecting motion of one or more characters controlled by the plurality of users on a game map (e.g., movement of a character, a skill or item use of the character, or the like) and should generate an image corresponding to the result. Thus, to calculate the result of performing the game, the computer should convert the conversion input operation input from the user on the conversion game image 100 with respect to the reference game image.

The computer may convert the conversion input operation into the reference input operation by reversely applying the manner of converting the reference game image into the conversion game image 100. For example, if receiving a selection operation for specific ability in the control key 220 and if receiving a selection operation on a specific counterpart character or point in the conversion game image 100, the computer may determine ability to be applied based on the selection operation for the specific ability and may convert information about a location where a selection operation on an ability application point in the conversion game image 100 is input into a location information on the reference game image.

If using the product of a transform matrix when converting the reference game image into the conversion game image 100, the computer may calculate location information in the reference game image by multiplying location information in the conversion game image 100 to apply specific ability by an inverse matrix of the transform matrix.

In operation S600, the computer may apply the movement or the ability use of the character based on the reference input operation. In other words, the computer may calculate a real-time game result by applying the reference input operation determined based on the conversion input operation in game developments (i.e., applying movement or skill use of the character) and may generate a reference game image of each view point.

The above-mentioned method for providing the game based on the touch screen according to an embodiment of the inventive concept may be implemented with a program (or an application) to be combined with a computer which is hardware and be executed and may be stored in a medium.

For the computer to read the program and execute the methods implemented with the program, the above-mentioned program may include a code coded into a computer language such as C, C++, Java, or a machine language readable through a device interface of the computer by a processor (CPU) of the computer. Such a code may include a functional code associated with a function and the like defining functions necessary for executing the methods and may include a control code associated with an execution procedure necessary for the processor of the computer to execute the functions according to a procedure. Further, such a code may further include a code associated with memory reference about whether additional information or media necessary for the processor of the computer to execute the functions is referred at any location (address number) of an internal or external memory of the computer. Further, if it is necessary for the processor of the computer to communicate with any computer or server located in a remote place to execute the functions, the code may further include a communication related code about how communication is performed with any computer or server located in a remote place using a communication module of the computer and whether to transmit and receive any information or media upon communication.

The medium may refer to a device-readable medium which stores data on a semipermanent basis rather than a medium, such as a register, a cache, or a memory, which stores data during a short moment. In detail, the medium may be, for example, but is not limited to, a read only memory (ROM), a random access memory (RAM), a compact disc ROM (CD-ROM), a magnetic tape, a floppy disc, an optical data storage device, or the like. In other words, the program may be stored in various storage media on various servers accessible by the hardware or various storage media on the hardware of the user. The medium may be distributed to a computer system connected over a network and may store a computer-readable code on a distributed basis.

According to an embodiment, if a plurality of users perform a game, since the computer convert a direction where one or more user's own characters move into the same direction and provide the same direction on a game image (i.e., a conversion game image) provided to each user, a movement direction of the character does not have an influence on character control of the user. Therefore, all users may perform combat based on statistics of their characters and character control abilities under the same condition.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for providing a game based on a touch screen, the method comprising:
obtaining, by a computer, a reference game image on which a plurality of characters operated according to a user input start from different points, the reference game image being obtained relative to a view point in a game space;
generating, by the computer, a conversion game image by converting the reference game image into the conversion game image as one or more characters corresponding to each user move from a first side to a second side; and
combining and providing, by the computer, an operation interface with the conversion game image.

2. The method of claim 1, further comprising:
receiving a conversion input operation through the operation interface, the conversion input operation being as an input operation of a user on the conversion game image;
converting the conversion input operation into a reference input operation, the reference input operation being as an input operation of the user on the reference game image; and
applying movement or ability use of a character based on the reference input operation.

3. The method of claim 2, wherein the operation interface comprises:
a movement key configured to determine a movement direction of the character; and
a control key configured to select ability used by the character,
wherein the movement key is located at a first side on a screen of a mobile terminal, and
wherein the control key is located at a second side on the screen of the mobile terminal.

4. The method of claim 3, wherein the game allows a first character according to an operation of a first user to use his or her ability while moving from the first side to the second side,
wherein the game allows a second character according to an operation of a second user to use his or her ability while moving from the second side to the first side, and
wherein the generating of the conversion game image comprises:
generating the reference game image as the conversion game image for the second user as the second character moves from the first side to the second side.

5. The method of claim 3, wherein the receiving of the conversion input operation comprises:
receiving a first selection input for ability of a second character displayed on the control key on the conversion game image; and
receiving a second selection input on an application point on the screen, and
wherein the application point is a first character which appears at the second side on the conversion game image as the first character starts from a location opposite to the second character on a game map or a region in a range from the first character.

6. The method of claim 1, wherein the generating of the conversion game image comprises:
generating the conversion game image by multiplying the reference game image by a projection matrix.

7. The method of claim 1, wherein the generating of the conversion game image comprises:
if a user performs a game with a virtual user, not performing a conversion process if a start point of a character of the user is determined as a first side on a symmetric game map or an asymmetric game map; and
generating the conversion game image by converting the reference game image into the conversion game image if the start point of the character of the user is determined as a second side on the asymmetric game map.

8. A program for providing a game based on a touch screen, the program being stored in a medium to be combined with a computer which is hardware and perform the method of claim 1.
